(19) United States
(12) Patent Application Publication
(10) Pub. No.: US 2006/0229988 A1
(43) Pub. Date: Oct. 12, 2006

(54) Card settlement method using portable electronic device having fingerprint sensor

(76) Inventors: Shunichi Oshima, Kowloon (HK); Hikaru Saito, Tokyo (JP); Tomoaki Narahara, Tokyo (JP); Shogo Nakazato, Tokyo (JP); Haruhiro Kikkawa, Tokyo (JP); Takeshi Ogi, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/542,888

(22) PCT Filed: Jan. 21, 2003
(86) PCT No.: PCT/JP03/00473

§ 371 Date: Mar. 28, 2006

(51) Int. Cl. G06Q 99/00

(52) U.S. Cl. 705/50

(57) ABSTRACT

In a card settlement system using a portable electronic device having a fingerprint sensor, a credit card and a portable electronic device (5) having a fingerprint sensor are issued to a person who has made application. To this electronic device (5), card information (12), a storage public key Kp1, and

### FIELD OF THE INVENTION

The present invention pertains to a portable electronic device having a fingerprint sensor used for card settlement of purchase charges for commodities, etc. ordered on a network. It also pertains to a card settlement method for safely performing card settlement of purchase charges for commodities, etc. ordered on a network using a portable electronic device having a fingerprint sensor.

### BACKGROUND OF THE INVENTION

When a settlement card such as a credit card, debit card, etc. is used to pay a commodity charge or service fee, it is necessary to confirm whether or not the card user is truly the card owner. At a store this identity confirmation is merely checking personal identification, such as the user's driver's license or passport, etc. Some settlement cards are imprinted with a photograph of the card owner's face. In this case, it is possible to confirm identity by comparing the facial photograph printed on the settlement card and the card user.

When identity confirmation at card settlement is done with a store employee face to face with the card user in a store, it can be done using personal identification or a facial photograph printed on a settlement card as described above. However, when paying a commodity charge or service fee on the Internet, for example, or when using a card settlement terminal without a store employee present (for example, when using a card settlement terminal installed at the pump of a gas service station) it is very difficult to confirm whether or not the card user is truly the card owner.

When settling using a settlement card on a network such as the Internet, it is generally almost always the case that settlement is concluded simply by entering the card number and card owner's name and expiration date. Nevertheless, the following sorts of problems currently remain in card settlement.

1) If a third party learns another person's card number by some method and uses it, that person can purchase a commodity on the Internet (impersonation)

2) Even if a card owner purchases a commodity on the Internet, he can pretend not to know about the purchase and not confirm the transaction.

Hitherto, the following sorts of methods have been employed or proposed for solving such problems.

First, Visa International has proposed a method called “3-D Secure” as a means for safely settling on the Internet. In this method each card owner registers a personally selected password or a secret question that specifies the individual (a pet's name, mother's maiden name, etc.) at the card company's server in advance. A company that sells a commodity or provides a service to the card owner on the Internet asks the buyer a question pertaining to the registered data previously registered at the card company's server, and confirms whether or not the buyer is truly the card owner.

Nevertheless, even if this method is used, the fact remains that the card number and password and answer to the secret question are entered “live” via a personal computer. Therefore there is no complete defense against “impersonation” by a malicious third party who is able to learn the entered data by some method. Also, this method can be used when doing card settlement on the Internet via a personal computer, but it cannot be employed when utilizing a card settlement terminal with absolutely no human intermediation, as in the case of a card settlement terminal installed at the pump of a gas service station, etc.

Next, U.S. Pat. Nos. 6,105,008 and 6,282,522 (Visa International) pertain to card settlement methods that use a so-called smart IC card; they propose a method wherein a useable amount of money is registered in the IC card in advance, and purchases can be made on the Internet only within the scope of that monetary amount. However, this method has the problem that the user has to check the remaining monetary amount each time, and it takes time and effort to add additional money. Also, it is not possible to eliminate the risk of improper use of the card by a third party if the card is lost or if the card is stolen.

Methods that use fingerprints have been proposed as methods for safe settlement on the Internet. For example, the method disclosed in U.S. Patent Application 2001/0018585 is one in which the user's own fingerprint data is used as a key for data encryption of the credit card number, etc. Nevertheless, in this method the user must register the user's own fingerprint data at a server on the network, and users have considerable psychological resistance to this. Also, the fingerprint is scanned by a fingerprint scanner attached to the card settlement terminal in the store and this data is sent on the network each time, etc. It is a system that does not take into account the view the average consumer has of fingerprints.

Similarly, the method disclosed in U.S. Patent Application 2001/0000535 also assumes that fingerprint data identifying the user has been registered at a server on the network in advance.

### SUMMARY OF THE INVENTION

The present invention is directed to providing a card settlement method that can reliably prevent improper use of a card by a third party by accurately and safely confirming identity when performing card settlement on the Internet. Specifically, it provides a card settlement method that uses fingerprint authentication as the identity confirmation means, allows only the authenticated person to do card settlement in such a manner that personal information including fingerprint information does not flow over the Internet, can ensure the confidentiality of settlement information through a simple and highly secure means, and additionally provides robust security wherein even the individual does not need to know the card number or password.

Also, the present invention is directed to providing a card settlement method that can precisely clarify the fact that a transaction is by the card owning individual when doing card settlement on the Internet and solve the problem of card owners not confirming the settlement transaction.

In addition, the present invention is directed to providing a portable electronic device having a fingerprint sensor suitable for use in a card settlement method for safely doing card settlement on the Internet.

In order to achieve these objectives, an exemplary embodiment of the present invention is a card settlement method wherein a portable electronic device having a fingerprint sensor is connected to a card company's card management device via a communication terminal for card settlement of a commodity purchase charge or the like; it is characterized by comprising:

An identity confirmation step wherein the portable electronic device having a fingerprint sensor reads the user's fingerprint using the fingerprint sensor and checks it against pre-registered fingerprint data and thereby confirms whether or not the user is the owner of the portable electronic device having a fingerprint sensor,

A transmission data generation and signature step wherein, when identity is confirmed, the portable electronic device having a fingerprint sensor encrypts commodity order information and pre-registered card information using a pre-registered transmission public key and generates transmission data, and electronically signs the transmission data using a pre-registered personal encryption key,

A transmission step wherein the electronically signed transmission data is sent from the side of the portable electronic device having a fingerprint sensor to the card management device, and

A decryption and settlement processing step wherein the card management device decrypts the electronically signed transmission data using a transmission secret key paired with the transmission public key and processes the settlement.

Preferably, the fingerprint data and the card information of the portable electronic device having a fingerprint sensor are registered in a state in which they are encrypted by a storage public key provided from the card management device side. In this case, decryption using the storage secret key paired with the storage public key may be performed in the step of decrypting the card settlement data at the card management device.

Preferably, the card management device stores and retains the received card settlement data for a predetermined time period.

Next, the card management device preferably updates the transmission public key and the storage public key registered in the portable electronic device having a fingerprint sensor as required. In this case, the portable electronic device having a fingerprint sensor may perform processing to replace the registered card information and fingerprint data with card information and fingerprint data that were encrypted using the updated storage public key.

Another exemplary embodiment of the present invention is a portable electronic device having a fingerprint sensor that connects to a card company's card management device via a communication terminal for card settlement of a commodity purchase charge or the like; it is characterized by comprising:

A fingerprint sensor, a storage unit, an external interface for connection to the communication terminal, and a processor for driving and controlling these units,

The storage unit stores the transmission public key and storage public key provided from the card management device side, card information for card settlement provided to the owner of the portable electronic device having a fingerprint sensor, master fingerprint data, and a personal encryption key,

The card information and master fingerprint data are stored in an encrypted state using the storage public key;

The processor comprises:

A personal encryption key generation means for generating a personal encryption key when the fingerprint sensor reads the master fingerprint data,

An identity confirmation means for confirming identity by comparing a fingerprint read by the fingerprint sensor against fingerprint data in the storage unit, and

A transmission data generation and transmission means for encrypting commodity order information and card information using the transmission public key and generating transmission data, for electronically signing the transmission data using the personal encryption key, and for sending the electronically signed transmission data to the card management device.

Here, the processor can be constituted to comprise a master fingerprint data registration means so that when it receives a registration permission signal from the card management device, it reads master fingerprint data using the fingerprint sensor and registers it. In this case, the personal encryption key generation means preferably generates the personal encryption key using the fingerprint data read when reading the master fingerprint data.

Next, an exemplary embodiment of the present invention is a card management device for performing card settlement of commodity purchase charges, etc. based on card settlement data received via a communication terminal from a portable electronic device having a fingerprint sensor; it is characterized by comprising:

An encryption key generation means for generating a storage public key and a transmission public key provided to the portable electronic device having a fingerprint sensor,

A registration procedure processing means for requesting identity identification information for determining the user when a registration request signal is received from the portable electronic device having a fingerprint sensor, and for sending a registration permission signal to the portable electronic device having a fingerprint sensor when the user is determined based on the received identity identification information,

A decryption means for decrypting the card settlement data using a storage secret key paired with the storage public key and a transmission secret key paired with the transmission public key when encrypted card settlement data is received from the portable electronic device having a fingerprint sensor, and

A settlement processing means for processing settlement based on the decrypted card settlement data.

Next, an exemplary embodiment of the present invention is a card settlement system that connects a portable electronic device having a fingerprint sensor to a card company's card management device via a communication terminal and performs card settlement of commodity purchase charges, etc.; it is characterized in that:

The portable electronic device having a fingerprint sensor comprises:

An identity confirmation means wherein the user's fingerprint is read using the fingerprint sensor and checked against pre-registered fingerprint data, thereby confirming whether or not the user is the owner of the portable electronic device having a fingerprint sensor,

A transmission data generation and signature means wherein, when identity is confirmed, commodity order information and pre-registered card information is encrypted using a pre-registered public key for transmission and transmission data is generated, and the transmission data is electronically signed using a pre-registered personal encryption key, and A transmission means for sending the electronically signed transmission data to the card management device;

The card management device comprises:

A reception means for receiving the electronically signed transmission data,

A decryption means for decrypting the received electronically signed transmission data using a transmission secret key paired with the transmission public key, and

A settlement processing means for processing settlement based on the decrypted electronically signed transmission data.

Preferably, the fingerprint data and card information of the portable electronic device having a fingerprint sensor are registered in a state in which they are encrypted by a storage public key provided from the card management device side. The card management device's decryption means preferably decrypts using a storage secret key paired with the storage public key.

Preferably, the card management device comprises a storage means for storing and retaining the received card settlement data for a predetermined time period.

In addition, the card management device preferably comprises an encryption key update means for updating the transmission public key and the storage public key registered in the portable electronic device having a fingerprint sensor. In this case, the portable electronic device having a fingerprint sensor preferably comprises a data update means for replacing the registered card information and fingerprint data with card information and fingerprint data that was encrypted using the updated storage public key.

### BRIEF DESCRIPTION OF THE DRAWINGS

FIG. 1 is a block diagram showing a card settlement system employing the present invention.

FIG. 2 is a block diagram showing the portable electronic device having a fingerprint sensor of FIG. 1.

FIG. 3 is a diagram explaining the registration procedure in the card settlement system of FIG. 1.

FIG. 4 is a diagram explaining the card settlement procedure in the card settlement system of FIG. 1.

### DETAILED DESCRIPTION OF THE PREFERRED EMBODIMENT

An embodiment of a card settlement system employing the present invention's card settlement method is explained below with reference to the drawings.

System Structure

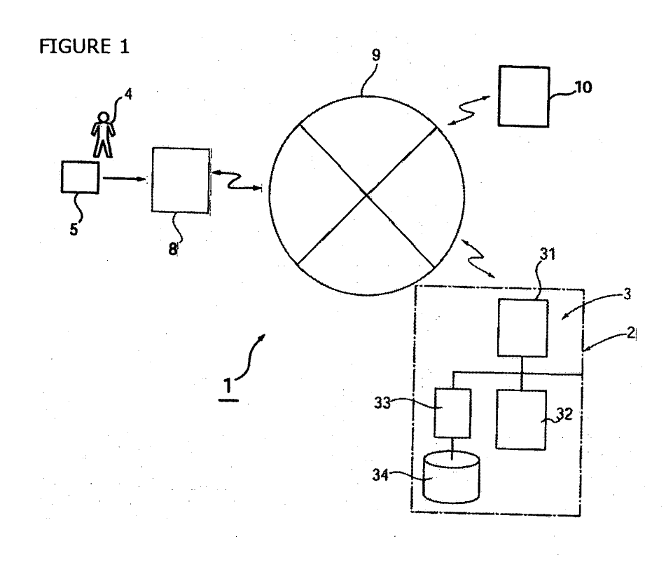

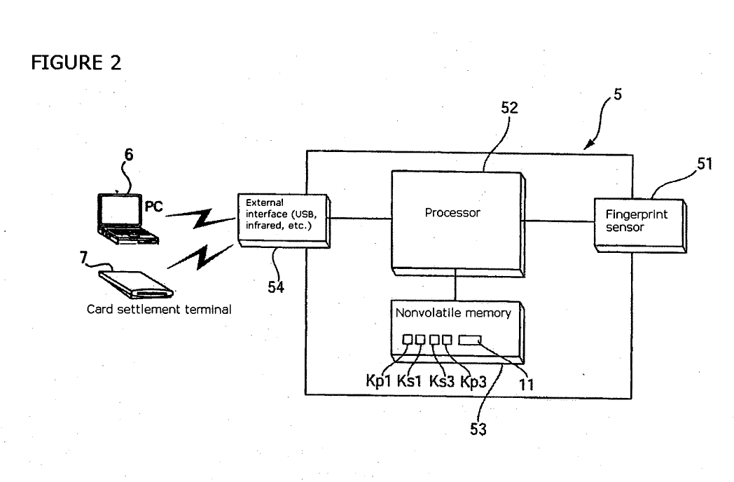

FIG. 1 is a block diagram showing the structure of one example of a card settlement system, and FIG. 2 is a block diagram of a portable electronic device having a fingerprint sensor. A card settlement system 1 includes a card management device 3 installed at the card company 2 side, a portable electronic device 5 having a fingerprint sensor provided to an owner 4 of a settlement card such as a credit card, etc. by the card management company 2, and a communication terminal 8 such as a personal computer 6 or card settlement terminal 7 capable of connecting the portable electronic device 5 having a fingerprint sensor. Also, there is a network such as the Internet 9 capable of connecting the portable electronic device 5 having a fingerprint sensor and the card management device 3.

The portable electronic device 5 having a fingerprint sensor is issued by the card company 2 together with a credit card to a person who applies for a card. When the card applicant receives the portable electronic device 5 having a fingerprint sensor, the applicant accesses the card company 2's card management device 3 via the communication terminal 8 and the Internet 9 and does a registration procedure to utilize the credit card. When the registration procedure is complete, it becomes possible to pay a charge for a commodity purchased at an online shipping site 10 on the Internet 9 through card settlement using the portable electronic device 5 having a fingerprint sensor.

The portable electronic device 5 having a fingerprint sensor includes a fingerprint sensor 51, a processor 52 for extracting and comparing fingerprint data, a nonvolatile memory 53 for storing fingerprint data and other data, and an external interface 54 for communication with the communication terminal 8.

Written into the nonvolatile memory 53 are a public key Kp1 for encrypting and storing card information (hereinafter “storage public key”) and a public key Kp2 for additionally encrypting the encrypted card information and sending it to the card management device 3 (hereinafter “transmission public key”). Also written into the memory are the card owner's own secret key Ks3 and public key Kp3 generated using fingerprint data. For example, this sort of secret key and public key can be generated using fingerprint data noise. The card owner's master fingerprint data 11 is also registered.

Meanwhile, the card company 2's card management device 3 includes a front server 31 that is a web server, a settlement server 32, an archive server 33, and a database 34 for storing the card transaction history, etc. The front server 31 decrypts information received via the Internet 9 and passes it to the settlement server 32. The front server 31 holds the transmission secret key Ks2 paired with the transmission public key Kp2 held by the portable electronic device 5 having a fingerprint sensor and the storage secret key Ks1 paired with the storage public key Kp1 . Received information is decrypted using these secret keys Ks1 and Ks2. Furthermore, in this example the public key and encryption key and electronic signature systems all conform to the specifications of PKI.X.509.

Registration Procedure

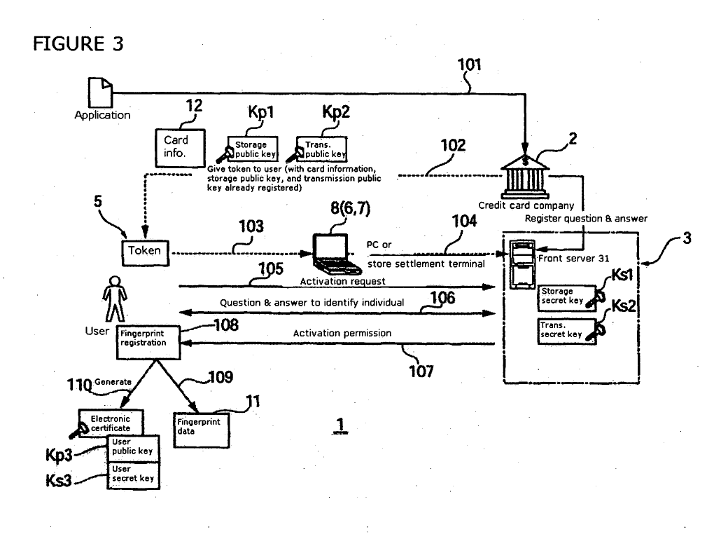

Before using the card settlement system 1 in this example, it is necessary to issue the portable electronic device 5 having a fingerprint sensor and do a registration procedure. This procedure shall be explained with reference to FIG. 3.

First, when a person applying for a credit card does the card application procedure with the card company 2 by mail or online (arrow 101), the card company 2 issues the applicant the portable electronic device (token) 5 having a fingerprint sensor and a credit card (arrow 102).

When the portable electronic device 5 having a fingerprint sensor is issued, the card company 2 writes the following information into the nonvolatile memory 53 of the portable electronic device 5 having a fingerprint sensor.

1) Storage public key Kp1 for encrypting and storing card information

2) Transmission public key Kp2 for further encryption of encrypted card information and transmission thereof

3) Card information 12

As soon as the applicant receives the portable electronic device 5 having a fingerprint sensor and the credit card from the card company 2, the applicant connects the portable electronic device 5 having a fingerprint sensor to a communication terminal 8 such as a personal computer 6 (arrow 103). Then the applicant accesses the URL indicated by the card company 2 via the communication terminal 8 and the Internet 9, establishes communication with the card management device 3's front server 31 (arrow 104), and issues a registration request signal (activation request) (arrow 105).

Subsequently, the Social Security number or driver's license number reported when the card applicant requested a card are checked, and the secret question (a pet's name, mother's maiden name, etc.) is asked on the web (confirmation of identity identification information), and the identity is confirmed (arrow 106). When the card company's front server 31 confirms that the question answerer is truly the card applicant, the card company 2's front server 31 sends a registration permission signal (activation permission signal) to initiate fingerprint data registration to the portable electronic device 5 having a fingerprint sensor (arrow 107). As a result, the card applicant is formally registered as a card member 4 at the card company 2 side.

The message “please place finger on the portable electronic device having a fingerprint sensor” is displayed on the screen of the communication terminal 8 that received the activation permission signal. The card member 4 obeys the message and his finger is scanned by the fingerprint sensor. Fingerprints are registered for more than one finger, so the same instruction is repeated (block 108).

When the portable electronic device 5 having a fingerprint sensor confirms that the required fingerprint data is in order, the fingerprint data is registered in the nonvolatile memory as master fingerprint data 11 (arrow 109). At the same time, the card member 4's personal secret key Ks3 and personal public key Kp3 are generated using the fingerprint data. For example, the card member 4's personal secret key Ks3 and personal public key Kp3 are generated using the noise that accompanies the fingerprint data when acquiring the fingerprint data. These keys are utilized for creating an electronic certificate.

Card Settlement Procedure

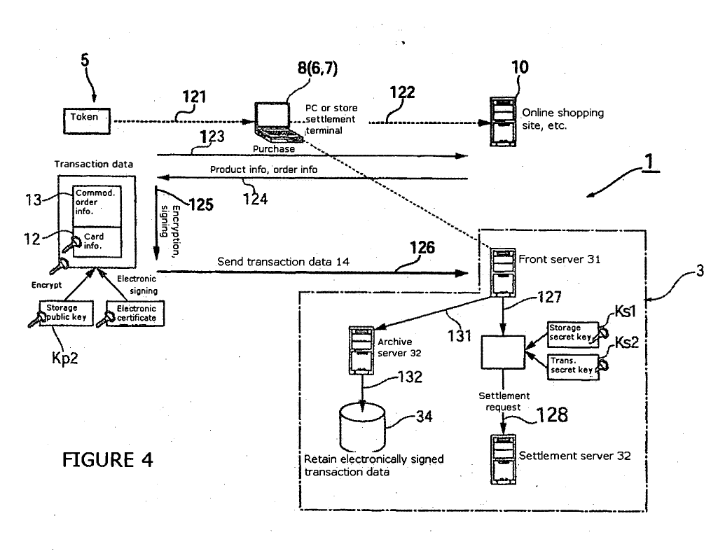

Next, the card settlement procedure on the Internet in this example of the card settlement system 1 shall be explained with reference to FIG. 4.

When the card member 4 purchases a commodity or receives provision of a service on the Internet 9, the portable electronic device 5 having a fingerprint sensor is connected to the communication terminal 8 (arrow 121) and an online shopping site 10 is accessed via the communication terminal 8 (arrow 122). When a commodity is purchased via the communication terminal 8 (arrow 123), commodity information and order information are sent from the online shopping site 10 side (arrow 124).

When settling the purchase charge for the ordered commodity, instead of entering a card number for settlement the fingerprint sensor 51 of the portable electronic device (token) 5 having a fingerprint sensor scans the finger corresponding to the registered fingerprint. If the master fingerprint data 11 stored in the nonvolatile memory 53 matches the fingerprint data of the scanned finger, the portable electronic device 5 having a fingerprint sensor recognizes that the card member 4 is doing a settlement transaction, and uses the transmission encryption key Kp2 to encrypt the card information 12 encrypted by the storage encryption key Kp1 written by the card company 2 and information 13 pertaining to the purchased commodity (commodity order information). At the same time this is electronically signed with the card member 4's personal public key Kp3 and secret key Ks3 (arrow 125). Then the encrypted and electronically signed transmission data (transaction data with an electronic signature) 14 is sent via the Internet 9 to the card company 2's front server 31 (arrow 126). The significance of an electronic signature is to prevent the card member 4 from not confirming the settlement transaction.

When the card company 2's front server 31 receives the electronically signed transaction data 14 it decrypts it with the secret key Ks2 paired with the transmission encryption key Kp2, and additionally decrypts it with the secret key Ks1 paired with the storage encryption key Ks1 , and decrypts the card information 12 (block 127). Then the settlement server 32 is asked for settlement (arrow 128). That is, processing shifts to a settlement process that is the same as a conventional one. Also, the electronically signed transaction data 14 that was sent can be kept in a long-term archive in order to prevent the card member 4 from denying the settlement transaction, etc. (arrows 131, 132).

Thus in the card settlement system 1 of this example an electronic signature is applied using the individual's secret key Ks3 generated in the portable electronic device 5 having a fingerprint sensor, so this determines that the card member himself, who is the owner of the registered fingerprint, used the portable electronic device 5 having a fingerprint sensor and did a settlement transaction. Also, the encrypted data is decrypted using the card company 2's front server 31 's secret keys Ks1 and Ks2, thereby determining that the data itself was sent from the portable electronic device 5 having a fingerprint sensor that was issued by the card company.

Because of these two points it is possibly to reliably determine the person who did the card settlement, and determining the genuineness of the portable electronic device 5 having a fingerprint sensor that was used can be reliably done. Therefore it is possible for the card company 2 to implement a network settlement method that has very high safety.

If the portable electronic device 5 having a fingerprint sensor is connected to the Internet 9 via the communication terminal 8 such as a personal computer 6, etc., it communicates online with the card company 2's settlement server 32. Therefore it is possible for the card company 2 to change the storage public key Kp1 and the transmission public key Kp2 written to the portable electronic device 5 having a fingerprint sensor when necessary. By doing so, it is possible to additionally enhance the security of the encryption keys used for encryption. Furthermore, when the encryption keys are revised, the data written in the nonvolatile memory 53 needs to be updated by data that was encrypted using the new encryption keys.

Next, the foregoing example is the charge settlement procedure when purchasing a commodity, etc. via the Internet. The card settlement system 1 in this example is one that can also be used when purchasing ordinary commodities or services using card settlement, such as when using a card without human intermediation, as in the case of a card settlement terminal at the pump of a gas service station, etc. In this case, by connecting the electronic device 5 to the card settlement terminal 7 of a pump at a gas service station the user can be determined, the card settlement transaction can be electronically signed, and the genuineness of the portable electronic device 5 having a fingerprint sensor can be determined.

### INDUSTRIAL APPLICABILITY

As described above, the card settlement method using the inventive portable electronic device having a fingerprint sensor has absolutely no external output of the card member's fingerprint data registered inside the electronic device. Fingerprint data is used only for the electronic device to recognize the identity of the card member. The keys stored in the electronic device for encrypting the information needed for settlement such as the card number, etc. can be arbitrarily determined by the card issuing company and can be changed and reregistered at any time. Therefore it is possible to realize a card settlement method that is safer and more useful for both the card member and the card company and that respects the card member's privacy.

That is, the present invention provides the following sorts of operations and effects.

1) Data related to card information is not sent to the card company's server unless there is a match with the fingerprint of the card member. Also, an electronic signature is provided using the card member's personal secret key stored in the portable electronic device having a fingerprint sensor.

Therefore the card company can always confirm that a settlement request is from the actual card member, and impersonation by a third party can be prevented. Also, the card member cannot lie about doing card settlement and say he didn't do it (failure to confirm).

2) The card member does not need to know his own card number, so there is no concern about the card number leaking to another party through human error on the part of the card member.

3) Data related to card information output from the portable electronic device having a fingerprint sensor is always output after encryption with a public key (paired with the secret key of the card company's server) written in the electronic device by the card company in advance. At the same time, the data is electronically signed with card member's personal secret key. Therefore, even if the data were stolen or falsified by some method, it could not be misused.

4) “Raw card information” such as the card number is stored in the memory of the portable electronic device having a fingerprint sensor after being encrypted with a public key written to the electronic device in advance by the card company. Also, it is not output to outside the electronic device without addition encryption. Therefore card information can be stored with a high degree of safety.

Even if by chance the portable electronic device having a fingerprint sensor were lost, the electronic device could not be used unless there was a match with the fingerprint data identifying the card member, and the stored card data is encrypted. Therefore the risk of someone using a lost or stolen portable electronic device having a fingerprint sensor is slight. Also, more secure operation could be achieved by incorporating a self-destruct function (making it “tamper resistant”) in case someone attempted to take the data by an illegal means.

5) As with “raw card information,” the registered fingerprint data of the card member is also stored only inside the portable electronic device having a fingerprint sensor and is never output to outside the electronic device. Therefore from the perspective of maintaining individual security, it is more acceptable to the card member.

6) A card company can use the present invention's card settlement method simply by adding a front server that is a PKI-type encryption key server to the front of an existing settlement server, so changes to existing settlement systems are very slight.

7) If an interface function for connection to a personal computer and a function for wireless (radio waves, infrared rays, etc.) communication with an existing card settlement terminal are added to the portable electronic device having a fingerprint sensor, the scope for using the present invention's card settlement method can be greatly broadened. That is, aside from Internet settlement, at the card settlement terminals of staffless shops where at present it is extremely difficult to determine if the card member is using the card or not, simply by adding a wireless receiving unit to the settlement terminal side it is possible the use the present invention's card settlement method and to resolve same existing problems with Internet settlement.

8) If the card company can do online rewrites of the encryption keys for encrypting card information stored inside the portable electronic device having a fingerprint sensor when necessary, high security can be maintained between the electronic device and the card company's settlement server.

1. A card settlement method using a portable electronic device having a fingerprint sensor connected to a card company's card management system via a communication terminal for settling commodity purchase charges or the like comprising:
confirming the identity of a user by using a portable electronic device having a fingerprint sensor to read the user's fingerprint check the reading against pre-registered fingerprint data to determine whether or not the user is the owner of said portable electronic device having a fingerprint sensor;
if the user is confirmed as the owner of the portable electronic device having a fingerprint sensor, using said portable electronic device having a fingerprint sensor to encrypt commodity order information and pre-registered card information using a pre-registered transmission public key to generate transaction data, and electronically sign the generated transaction data using a pre-registered personal encryption key:
transmitting said electronically signed transaction data from said portable electronic device having a fingerprint sensor to said card management device system: and
at said card management system, decrypting said electronically signed transaction data using a transmission secret key paired with said transmission public key to obtain said commodity order information and settle purchase charges associated with said commodity order.

2. A card settlement method using a portable electronic device having a fingerprint sensor according to claim 1, wherein
said pre-registered fingerprint data and said pre-registered card information are registered in a state in which they are encrypted by a storage public key provided by said card management system; and
said decrypting said electronically signed transaction data by said card management system includes using a storage secret key paired with said storage public key.

3. A card settlement method using a portable electronic device having a fingerprint sensor according to claims 1 or 2, wherein:
said card management system stores and retains the received electronically signed transaction data for a predetermined time period.

4. A card settlement method using a portable electronic device having a fingerprint sensor according to claim 2, further comprising:
said card management device system updating said pre-registered transmission public key and said storage public key; and
said portable electronic device having a fingerprint sensor replacing said pre-registered card information and said pre-registered fingerprint data with updated pre-registered card information and updated pre-registered fingerprint data encrypted using said updated storage public key.

5. A portable electronic device having a fingerprint sensor suitable for connecting to a card company's card management system via a communication terminal for settlement of a commodity purchase charges or the like, comprising:
(a) a fingerprint sensor;
(b) a storage unit;
(c) an external interface for coupling to said communication terminal; and
(d) a processor for and controlling the operation of these units.
Wherein:
(i) said storage unit stores: a transmission public key and a storage public key provided by said card management system, card settlement information provided to the owner of the portable electronic device having a fingerprint sensor, master fingerprint data, and a personal encryption key;
wherein said card settlement information and said master fingerprint data are stored in an encrypted state using said storage public key; and
(ii) said processor comprises:
(1) a personal encryption key generation means for generating said personal encryption key when said fingerprint sensor reads said master fingerprint data,
(2) an identity confirmation means for confirming identity by comparing a fingerprint read by said fingerprint sensor against said master fingerprint data stored in said storage unit, and
(3) a transaction data generation and transmission means for encrypting commodity order information and said card settlement information using said transmission public key to secure the transaction data, for electronic signing said generated transaction data using said personal encryption key, and for sending the electronically signed transaction data to said card management system.

6. A portable electronic device having a fingerprint sensor according to claim 5, wherein:
said processor also comprises a master fingerprint data registration means that in response to receiving a registration permission signal from said card management system, reads said master fingerprint data using said fingerprint sensor and registers said master fingerprint data, and
said personal encryption key generation means generates said personal encryption key using the read master fingerprint data.

7. A card management system for settling commodity purchase charges or the like based on transaction data received via a communication terminal from a portable electronic device having a fingerprint sensor, comprising:
an encryption key generation means for generating a storage public key and a transmission public key provided to said portable electronic device having a fingerprint sensor;
a registration procedure processing means for requesting identity identification information for determining a user when a registration request signal is received from said portable electronic device having a fingerprint sensor, and for sending a registration permission signal to said portable electronic device having a fingerprint sensor when the user is determined based on the received identity identification information;
a decryption means for decrypting said transaction data using a storage secret key paired with said storage public key and a transmission secret key paired with said transmission public key when encrypted and electronically signed transaction data is received from said portable electronic device having a fingerprint sensor; and
a settlement processing means for processing settlement based on said decrypted transaction data.

8. A card settlement system that connects a portable electronic device having a fingerprint sensor to a card company's card management system via a communication terminal and performs card settlement of commodity purchase charges or the like, wherein:
(a) said portable electronic device having a fingerprint sensor comprises:
(i) an identity confirmation means the for reading a user's fingerprint using said fingerprint sensor and comparing said read fingerprint data against pre-registered fingerprint data to determine whether or not the user is the owner of said portable electronic device having a fingerprint sensor,
(ii) a transaction data generation and signature means for, after the identity of the user is confirmed, encrypting commodity order information and pre-registered card information using a pre-registered transmission public key to generate transaction data and electronically signing said transaction data using a pre-registered personal encryption key, and
(iii) a transmission means for sending said electronically signed transaction data to said card management system; and
(b) said card management system comprises:
(i) a reception means for receiving said electronically signed transaction data,
(ii) a decryption means for decrypting said received electronically signed transaction data using a transmission secret key paired with said transmission public key, and
(iii) a settlement processing means for processing settlement based on said decrypted transaction data.

9. A card settlement system that uses a portable electronic device having a fingerprint sensor according to claim 8, wherein:
said pre-registered fingerprint data and said pre-registered card information of said portable electronic device having a fingerprint sensor are registered in a state in which they are encrypted by a storage public key provided by said card management system; and
said card management system's decryption means decrypts using a storage secret key paired with said storage public key.

10. A card settlement system that uses a portable electronic device having a fingerprint sensor according to claims 8 or 9, wherein:
said card management system also comprises a storage means for storing and retaining said received transaction data for a predetermined time period.

11. A card settlement system that uses a portable electronic device having a fingerprint sensor according to claim 9, wherein:
said card management system also comprises an encryption key update means for updating said transmission public key and said storage public key; and
said portable electronic device having a fingerprint sensor comprises a data update means for replacing said pre-registered card information and said pre-registered fingerprint data with updated pre-registered card information and updated pre-registered fingerprint data encrypted using said updated storage public key.

12. A card settlement system that uses a portable electronic device having a fingerprint sensor according to claim 10, wherein:
said card management system also comprises an encryption key update means for updating said transmission public key and said storage public key; and
said portable electronic device having a fingerprint sensor comprises a data update means for replacing said pre-registered card information and said pre-registered fingerprint data with updated pre-registered card information and updated pre-registered fingerprint data encrypted using said updated storage public key.

13. A card settlement method using a portable electronic device having a fingerprint sensor according to claim 3, further comprising:
said card management system updating said pre-registered transmission public key and said storage public key; and
said portable electronic device having a fingerprint sensor replacing said pre-registered card information and said pre-registered fingerprint data with updated pre-registered card information and updated pre-registered fingerprint data encrypted using said updated storage public key.
